(19) United States
(12) Patent Application Publication
(10) Pub. No.: US 2016/0335580 A1
(43) Pub. Date: Nov. 17, 2016

(54) SYSTEMS, DEVICES, AND METHODS FOR CONFIGURING A GRAPHICAL USER INTERFACE

(71) Applicant: Wal-Mart Stores, Inc., Bentonville, AR (US)

(72) Inventors: Nicholaus Adam Jones, Fayetteville, AR (US); Matthew Allen Jones, Bentonville, AR (US); Robert James Taylor, Rogers, AR (US)

(21) Appl. No.: 15/154,415

(22) Filed: May 13, 2016

Related U.S. Application Data
(60) Provisional application No. 62/160,857, filed on May 13, 2015.

(51) Int. Cl. G06Q 10/06; G06F 3/0484; G06F 17/30; G06F 3/0481; G06Q 10/10; H04L 29/08; G09G 3/36

(52) U.S. Cl. CPC G06Q 10/06398; H04L 67/22; G06F 3/0484; G09G 3/36; G06F 3/0481; G06Q 10/06393; G06Q 10/105; G06F 17/3053; G06F 17/30554; G09G 2380/04

(57) ABSTRACT

Provided herein are methodologies, systems, apparatus, and non-transitory computer-readable media for configuring a graphical user interface of an electronic display device for displaying and updating individual performance data. Activity data relating to one or more individuals may be collected and used to compute an impact parameter and performance ranking associated with an individual's employment activities. The impact parameters and performance rankings can be displayed on an electronic device via a GUI, and the impact parameters and performance rankings can be updated in real-time, or close to real-time. Updating the impact parameters and performance rankings in real-time reflects modifications die to activity data indicating a status or completion of one or more activities performed by the individual.

### RELATED APPLICATIONS

This application claims priority to U.S. Provisional Patent Application Ser. No. 62/160,857 entitled “SYSTEMS, DEVICES, AND METHODS FOR CONFIGURING A GRAPHICAL USER INTERFACE TO DISPLAY PERFORMANCE DATA,” filed on May 13, 2015, the content of which is hereby incorporated by reference in its entirety.

### BACKGROUND OF THE TECHNOLOGY

In general, workers within an enterprise may be graded and evaluated based on various activity and/or performance metrics. Certain existing performance monitoring techniques allow managers to track certain activities associated with a particular worker or associate and reward exceptional performance.

### SUMMARY

In accordance with exemplary embodiments, a method of configuring a graphical user interface is disclosed. The method includes receiving, in an electronic computer-readable format, activity data relating to one or more activities performed by an individual. The activity data includes an indication of a status of completion of the one or more activities. The method also includes computing an impact parameter associated with the individual, wherein the impact parameter is quantified using a metric based on predefined measures of the net value of the individual's performance with respect to the one or more activities. The method also includes computing a performance ranking associated with the individual, based on the one or more activities performed by the individual. The method also includes rendering a graphical user interface on an electronic display device, the graphical user interface comprising a graphical indication of the impact parameter, and a graphical indication of the performance ranking. The method also includes updating the graphical user interface, in real-time, to indicate a modification of the graphical indication of the performance ranking and/or a modification of the graphical indication of the impact parameter, based on the activity data indicating completion of the one or more activities.

In some examples, the impact parameter includes a real money value reported as a result of the one or more activities performed by the individual. In some examples, the impact parameter includes an increase in a customer satisfaction rating resulting from the one or more activities performed by the individual. In some examples, the graphical user interface also includes a graphical indication of the individual's progress in completing individual-specific goals relating to the individual's projected career path. In some examples, performing a task at an improper time negatively effects the performance ranking or the impact parameter associated with the individual. In some examples, an audit request is received at a computing terminal, and the audit request is initiated by a second individual or coworker, requesting an audit of the one or more activities performed by the individual. In some examples, the activity data is input manually by the individual's manager or supervisor. In some examples, the electronic display device is a mobile electronic device. In some examples, the electronic display device is a wearable electronic-paper badge or a liquid crystal display (LCD) badge. In some examples, the graphical user interface also includes a graphical indication of an achievement earned by the individual in response to performing one or more specific tasks.

Any combination or permutation of the above examples is envisioned. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present disclosure will be more fully understood from the following description of exemplary embodiments when read together with the accompanying drawings, in which:

FIG. 1 is a flowchart illustrating an exemplary method of configuring a graphical user interface of an electronic display device, according to embodiments of the present disclosure.

FIG. 2 is a flowchart illustrating another exemplary method of configuring a graphical user interface of an electronic display device, according to embodiments of the present disclosure.

FIG. 3 depicts an exemplary electronic display device for rendering and configuring a graphical user interface, according to embodiments of the present disclosure.

FIG. 4 is a diagram of an exemplary network environment suitable for a distributed implementation of exemplary embodiments of the present disclosure.

FIG. 5 is a block diagram of an exemplary computing device that can be used to perform exemplary processes in accordance with exemplary embodiments of the present disclosure.

### DETAILED DESCRIPTION

Following below are more detailed descriptions of various concepts related to, and embodiments of, inventive methods, apparatus, and systems for configuring a graphical user interface to facilitate displaying individual performance data. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means includes but is not limited to, the term “including” means including but not limited to. The term “based on” means based at least in part on.

Example methodologies, systems, apparatus, and non-transitory computer-readable media are described herein to facilitate configuring a graphical user interface of an electronic display device to facilitate displaying and updating individual performance data on a mobile electronic device. According to some examples, activity data associated with an individual, such as tasks or activities completed along with the timing of completing those tasks, is received by the system. The activity data can then be stored in a database and used to compute individual impact parameters and performance rankings, as disclosed herein. These impact parameters and performance rankings can be displayed and updated in real-time, or close to real-time, via a GUI of an electronic display device. The performance ranking can display an indication of an individual's performance of certain tasks as compared to other coworkers. The impact parameter may include, for example, a monetary value associated with tasks or activities performed by the individual. For example, if the individual is a cashier at a checkout station, the amount of sales and/or profits recorded by every item the cashier scans can be used to determine a real dollar amount corresponding to the individual's activities. In another example, the dollar value of all the items placed on store shelves can be used to determine a dollar amount corresponding to the activities of a re-stocking associate.

As will be appreciated, the activity data used to compute the various impact parameters and/or performance rankings disclosed herein may include, for example, numerical and/or statistical data corresponding to an individual's performance with respect to various work activities that can be quantified according to a metric. As non-limiting examples, such quantifiable work activities can include one or more of the following: scanning items at a point of sale terminal, re-stocking items on a shelf, loading or unloading products into or from a storage area, returning carts from the parking lot to a store entrance, greeting customers as they enter a store, cleaning the floors or bathrooms, helping customers bring items to their vehicle, serving customers at a deli counter or pharmacy center, assisting a customer with finding a product, or any other activity performed by a worker within an enterprise. Work activity data of an individual can be tracked, stored, and processed by the enterprise, and in some cases is tracked based on the individual's specific ID or login information. The activity data can be collected, for example, via a scanner or barcode reader associated with a point of sale terminal or a mobile scanner used by the individual. In another example, the activity data can be input manually by the individual's manager or supervisor. A manager or supervisor may also input performance or career goals for individuals. The goals can be used in the computation of an individual's performance metrics, rankings, or achievements, and they may be set on a general or individual level. In some examples, the number and/or type of achievements associated with an individual can depend on the individual's progress toward completion of certain goals, which can be set by the individuals themselves and/or their managers or supervisors.

Once the data is collected or captured, it is processed to compute the impact parameters, achievements, and performance rankings relating to the individual. A digital display device can then display the individual's performance achievements, impact parameters, and/or individual ranking, similar to the way a baseball card displays an athlete's statistics, such that the individual can receive recognition for work being performed. In some cases, an individual's activity can negatively impact an individual's achievements, impact parameters, and/or performance ranking. For example, during peak shopping hours associates can be encouraged to restock shelves rather than count the current items in a store. Accordingly, if an individual spends time counting items during peak shopping hours, or when the shelves are not properly re-stocked, that individual's achievements and/or ranking may be reduced as an indicator of the individual's lower compliance. Parameters quantifying this reduction as a result of lower compliance can be updated in real time and displayed on the individual's display device. In an example, an individual's ranking and achievements may be made visible for others to see. In this example, a coworker may be provided with a procedure to question or corroborate an individual's achievements score. If a coworker possesses activity data or other information that may need to be included to more accurately reflect an individual's specific ranking or achievement, including potentially to lower an existing ranking or achievement score, the example systems, methods, and apparatus herein provide a procedure for introduction of such activity data or other information. Inputting an audit request, via an associate terminal, can initiate an audit of one or more activities associated with another coworker.

The display device can update in real-time, or close to real-time, as tasks are performed, and the device can be made visible (including publicly according to established procedures), for example, using an electronic-paper or LCD badge. In some cases, the display device can be a portable display device that an associate can wear, such as an E-ink device, an E-paper badge, or an Electronic Shelf Label (ESL)-type device, for example. The display device may also be incorporated into a display screen associated with a cashier station, point-of-sale system, or a portable device used by the individual such as a scanner.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

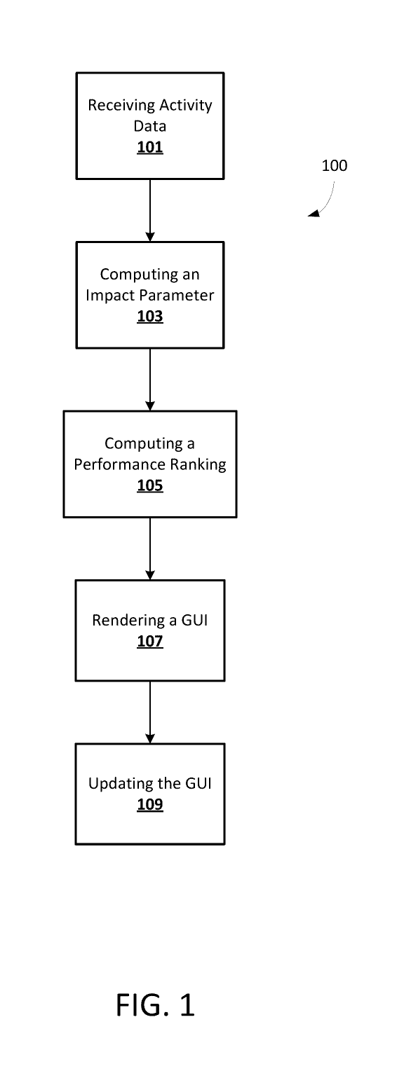

FIG. 1 is a flowchart illustrating an example method 100 for configuring a graphical user interface of an electronic display device, according to embodiments of the present disclosure. In step 101, a server receives activity data, in an electronic computer-readable format, relating to one or more activities performed by an individual. The activity data can include any quantifiable work activity according to the principles described herein, such as but not limited to, the number of scans performed per hour, the number of items or cases stocked in a given time, the number of items or cases loaded or unloaded in a given time, the amount of time spent greeting customers entering a store, the number of bathrooms cleaned, etc. The activity data can be collected, for example, via a scanner or barcode reader associated with a point of sale terminal or a mobile scanner used by the individual. In another example, the activity data can be input manually by the individual's manager or supervisor.

In step 103, an impact parameter associated with the individual is calculated. The impact parameter can be quantified using a metric based on predefined measures of the net value of the individual's performance with respect to one or more activities. Activities may include, as non-limiting examples, scanning items at a point of sale terminal, re-stocking items on a shelf, unloading products into a storage area, etc. The impact parameter can include a real money value reported as a result of the activities performed by the individual. For example, if the individual is a cashier at a checkout station, the amount of sales and/or profits recorded by every item the cashier scans can be used to determine a real dollar value corresponding to the individual's activities. In another example, the dollar value of all the items placed on store shelves can be used to determine a dollar value corresponding to the activities of a re-stocking associate. Additional activities, such as cleaning spills, can result in increased value to a store and therefore impact an individual's performance metrics. For example, increased floor cleanliness may increase sales on a particular aisle by a certain percentage. Thus, cleaning a spill in an aisle could lead to an increase in sales on that aisle corresponding to a certain dollar amount. The impact parameter can also include an increase in a customer satisfaction rating resulting from the activities performed by the individual. For example, the enterprise may be configured to make the association, based on historical customer satisfaction surveys, that clean bathrooms and shopping aisles generally contribute to 20% of a shopper's customer satisfaction. Accordingly, when an individual cleans the bathrooms or cleans a spill in a shopping aisle, the impact parameter associated with the individual may reflect a corresponding increase in customer satisfaction resulting from that particular activity. As described above, other enterprise activities, such as returning shopping carts to the front of the store, greeting customers as they enter a store, helping customers bring items to their vehicle, or helping a customer find a product may be used to determine the impact parameter and/or performance ranking associated with an individual.

In step 105, a performance ranking associated with the individual is computed. This performance ranking is based on the activities performed by the individual, such as scanning items at a point of sale terminal, re-stocking items on a shelf, unloading products into a storage area, etc. For example, the individual who scans the most items per hour would have the highest performance ranking for that specific task. The performance ranking may include an indication of an associates performance compared to other coworkers within a single store, or within the enterprise.

In step 107, a graphical user interface is rendered on an electronic display device that displays a graphical indication of the impact parameter computed in step 103 and a graphical indication of the performance ranking computed in step 105. The graphical user interface may also include a graphical indication of the individual's progress in completing individual-specific goals relating to the individual's projected career path. The electronic display device can be a display screen attached to or associated with a point of sale terminal or an individual's work station. In other cases, the electronic display device can be, for example, a mobile electronic device such as a wearable electronic-paper badge, an electronic LCD badge, a mobile scanning device, or any other suitable mobile display device that can be worn or carried by an individual.

In step 109, the GUI is updated in real-time to indicate a modification of the graphical indication of the performance ranking and/or a modification of the graphical indication of the impact parameter. This update is based on continued activity data that can indicate the status and/or completion of one or more activities performed by an individual. As discussed above, in some examples, performing a task at an improper time can negatively impact the performance ranking or the impact parameter associated with an individual, and this negative impact may be reflected in the real-time updates of the performance ranking and impact parameters.

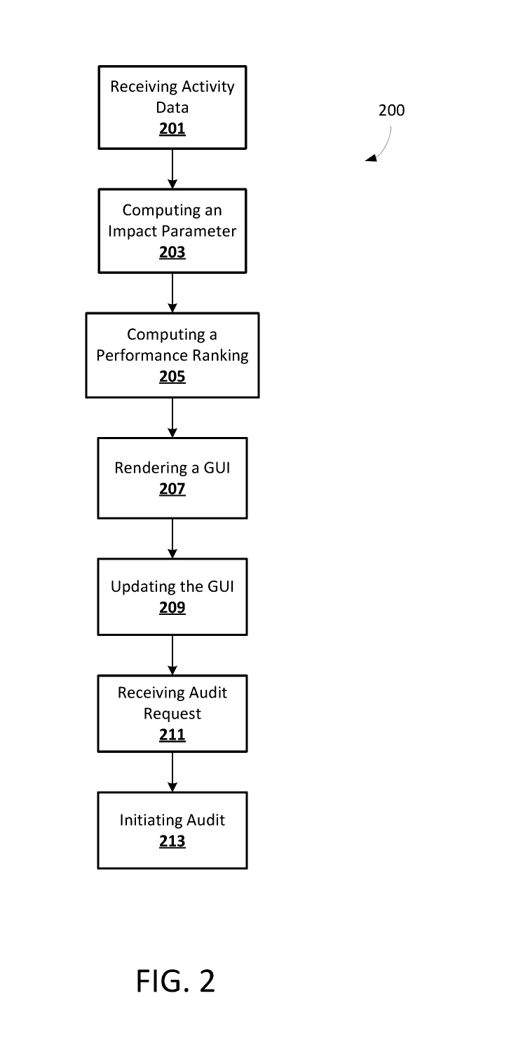

FIG. 2 is a flowchart illustrating another example method 200 for configuring a graphical user interface of an electronic display device, according to embodiments of the present disclosure. In step 201, a server receives activity data, in an electronic computer-readable format, relating to one or more activities performed by an individual. The activity data can include, for example, the number of scans performed per hour, the number of items or cases stocked in a given time, the number of items or cases loaded or unloaded in a given time, the amount of time spent greeting customers entering a store, the number of bathrooms cleaned, etc. The activity data can be collected, for example, via a scanner or barcode reader associated with a point of sale terminal or a mobile scanner used by the individual. In another example, the activity data can be input manually by the individual's manager or supervisor.

In step 203, an impact parameter associated with the individual is calculated. The impact parameter is quantified using a metric based on predefined measures of the net value of the individual's performance with respect to one or more activities. Activities may include, for example, scanning items at a point of sale terminal, re-stocking items on a shelf, unloading products into a storage area, etc. The impact parameter can include a real money value reported as a result of the activities performed by the individual. For example, if the individual is a cashier at a checkout station, the amount of sales and/or profits recorded by every item the cashier scans can be used to determine a real dollar value corresponding to the individual's activities. In another example, the dollar value of all the items placed on store shelves can be used to determine a dollar value corresponding to the activities of a re-stocking associate. The impact parameter can also include an increase in a customer satisfaction rating resulting from the activities performed by the individual. For example, the enterprise may be configured to make the association, based on historical customer satisfaction surveys, that clean bathrooms and shopping aisles are considered to contribute to 20% of a shopper's customer satisfaction. Accordingly, when an individual cleans the bathrooms or cleans a spill in a shopping aisle, the impact parameter associated with the individual may be revised to reflect a corresponding increase in customer satisfaction resulting from receipt of an indication of that particular activity data. As described above, other enterprise activities, such as returning shopping carts to the front of the store, greeting customers as they enter a store, helping customers bring items to their vehicle, or helping a customer find a product may be used to determine the impact parameter and/or performance ranking associated with an individual.

In step 205, a performance ranking associated with the individual is computed. This performance ranking is based on the activities performed by the individual, such as scanning items at a point of sale terminal, re-stocking items on a shelf, unloading products into a storage area, etc. For example, the individual who scans the most items per hour would have the highest performance ranking for that specific task. The performance ranking may include an indication of an associates performance compared to other coworkers within a single store, or within the enterprise.

In step 207, a graphical user interface is rendered on an electronic display device that displays a graphical indication of the impact parameter computed in step 203 and a graphical indication of the performance ranking computed in step 205. The graphical user interface may also include a graphical indication of the individual's progress in completing individual-specific goals relating to the individual's projected career path. The electronic display device can be a display screen attached to or associated with a point of sale terminal or an individual's work station. In other cases, the electronic display device can be, for example, a mobile electronic device such as a wearable electronic-paper badge, an electronic LCD badge, a mobile scanning device, or any other suitable mobile display device that can be worn or carried by an individual.

In step 209, the GUI is updated in real-time to indicate a modification of the graphical indication of the performance ranking and/or a modification of the graphical indication of the impact parameter. This update is based on continued activity data that can indicate the status and/or completion of one or more activities performed by an individual. As discussed above, in some examples, the performance of a task at an improper time can result in activity data that negatively impacts the performance ranking or the impact parameter associated with an individual, and this negative impact may be reflected in the real-time updates of the performance ranking and impact parameters.

In step 211, an audit request is received requesting an audit of the status of completion of one or more activities or tasks. As discussed above, because the performance metrics are publicly visible, at least during the first mode of operation, an associate or coworker can initiate an audit in order to verify the individual's specific performance metric, ranking, or achievement. Once the audit request is received in step 211, the audit is initiated in step 213. Once an audit is initiated, the system or an entity within the enterprise may act upon the audit and produce a confirmation of whether or not the work corresponding to the audit was accomplished. If the audit produces a negative result, the performance metrics associated with the individual and/or activities being audited can be updated accordingly. In some embodiments, if the same associate submits requests which rarely produce a negative result, audit requests by that associate may be disregarded.

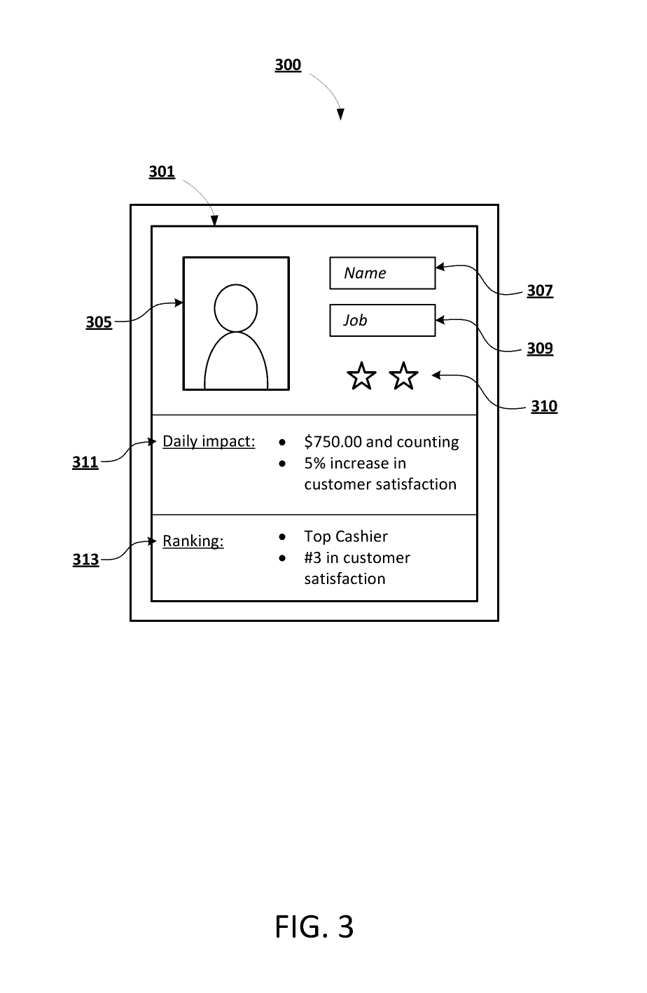

FIG. 3 depicts an exemplary electronic display device 300 for rendering and configuring a graphical user interface 301, according to embodiments of the present disclosure. As shown in this particular example, the GUI 301 can be configured to display an image of the individual 305, the individual's name 307, job title 309, achievements associated with the individual 310, and indications of various impact parameters 311 and rankings 313. The achievements 310 may include stars, trophies, or any other graphical indication recognizing an individual for the performance of a task or the completion of a performance goal. In some examples, the impact parameters 311 include, a monetary value associated with the individual's action, as well as a percent impact on customer satisfaction due to any activity or task performed by the individual.

In some examples, the performance ranking 313 includes a ranking corresponding to the individual's job title, as well as a ranking corresponding to the individual's impact on customer satisfaction. In this particular example, the individual is the top cashier, has contributed third-most to customer satisfaction (corresponding to a 5% increase in customer satisfaction), and has contributed to $750.00 worth in sales as a cashier.

In an example, the GUI can be configured to be updated in real-time to provide an indication of a modification of the graphical indication of the performance ranking and/or a modification of the graphical indication of the impact parameter. This update can be based on receipt of continued activity data that indicates the status and/or completion of one or more activities performed by an individual. As described above, in some examples, the performance of a task at an improper time can result in activity data that negatively impacts the performance ranking or the impact parameter associated with the individual, and this negative impact may be reflected in real-time updates of the GUI rendering of performance ranking and impact parameters.

In an example, the GUI can be configured to be update the display based on the results of an audit request received, requesting an audit of the status of completion of one or more activities or tasks of the individual. As described above, the GUI can be configured such that the performance metrics may be made publicly visible, at least during the first mode of operation. An associate or coworker may initiate an audit in order to verify the individual's specific performance metric, ranking, or achievement.

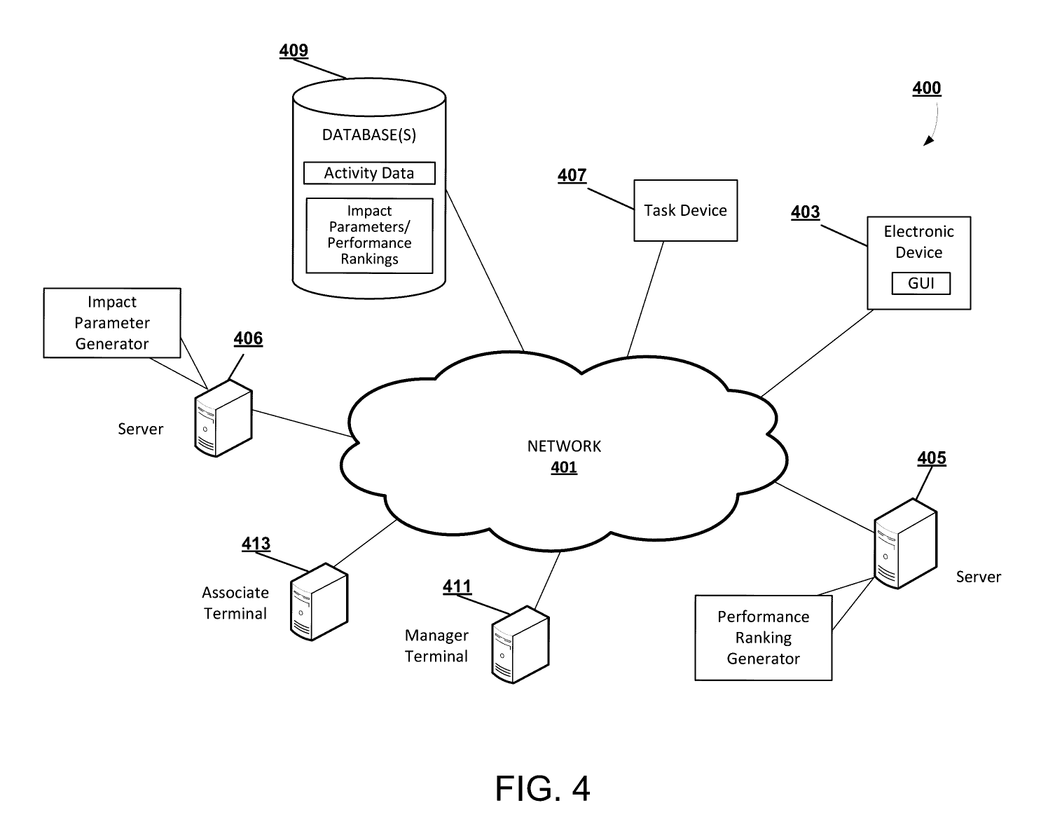

FIG. 4 is a diagram of an example network environment 400 suitable for a distributed implementation of example embodiments. The network environment 400 can include one or more servers 405 and 406. As will be appreciated, various distributed or centralized configurations may be implemented, and in some embodiments a single server can be used. The network environment may also include a database 409, associated with servers 405 and 406. In exemplary embodiments, the database 409 can store the various activity data, impact parameters, performance rankings, etc., while the one or more servers 405 and 406 can store an impact parameter generator and/or a performance ranking generator, which can implement one or more of the processes described herein with respect to FIGS. 1 and 2. The network environment may also include an electronic device 403, that may be configured to display at least one GUIs to a user as described above in reference to FIG. 3. Once the electronic device 403 receives instructions from the one or more servers 405 and 406, the GUI may be rendered on the electronic device 403 to allow a user of the client device 403 to interact with the servers to implement embodiments of the present disclosure. The network environment 400 can also include a task device 407, such as a scanning device an individual can use in counting inventory or performing other tasks. The network environment 400 can also include a manger terminal 411, which a manger or supervisor can interact with to input individual activity data or performance goals. The network environment 400 can also include an associate terminal 413, which an associate can interact with in order to initiate an audit request, as described above.

In exemplary embodiments, the servers 405 and 406, task device 407, database 409, manager terminal 411, associate terminal 413, and the electronic device 403 may be in communication with each other via a communication network 401. The communication network 401 may include, but is not limited to, the Internet, an intranet, a LAN (Local Area Network), a WAN (Wide Area Network), a MAN (Metropolitan Area Network), a wireless network, an optical network, and the like. In exemplary embodiments, the electronic device 403 that is in communication with the servers 405 and 406 and database 409 can generate and transmit a database query requesting information from the raw data matrices or database 409. As described above in reference to FIGS. 1-2, the one or more servers 405 and 406 can transmit instructions to the electronic device 403 over the communication network 401. The servers 405 and 406 can interact with the electronic device 403 and database 409 over communication network 401 to render the GUIs, e.g., shown in FIGS. 3A-3B, on the electronic device 403, as described above in reference to FIGS. 1-2.

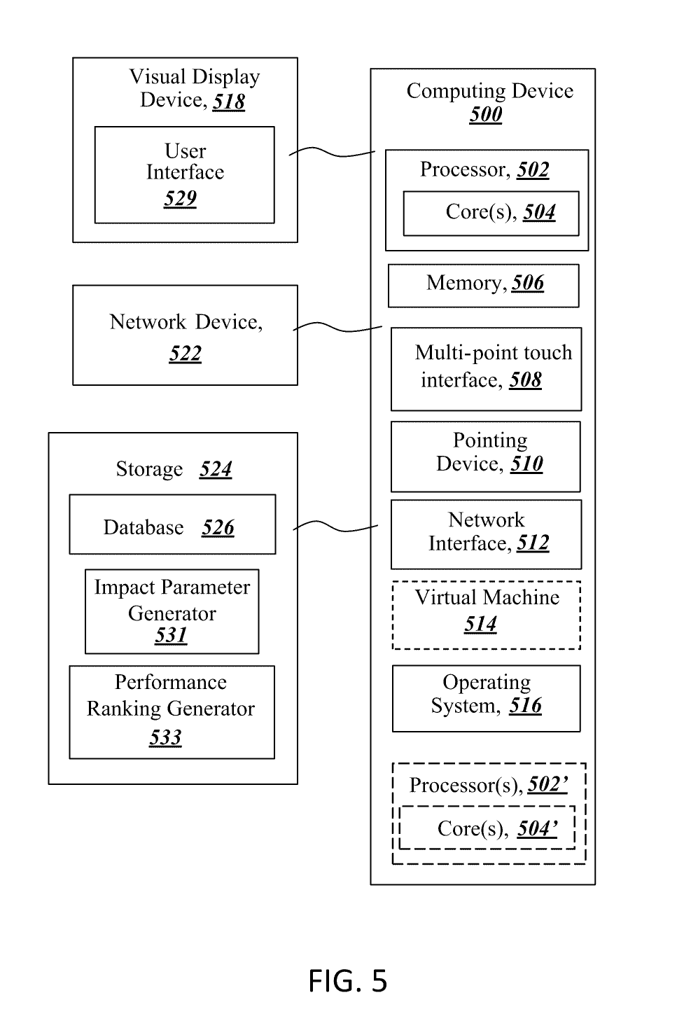

FIG. 5 is a block diagram of an exemplary computing device 500 that can be used in the performance of any of the example methods according to the principles described herein. The computing device 500 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like. For example, memory 506 included in the computing device 500 can store computer-readable and computer-executable instructions or software for implementing exemplary embodiments, such as an impact parameter generator 531 and/or performance ranking generator 533 programmed to perform processes described herein. The computing device 500 also includes processor 502 and associated core 504, and optionally, one or more additional processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ can each be a single core processor or multiple core (504 and 504′) processor.

Virtualization can be employed in the computing device 500 so that infrastructure and resources in the computing device can be shared dynamically. A virtual machine 514 can be provided to handle a process running on multiple processors so that the process appears to be using only one computing resource rather than multiple computing resources. Multiple virtual machines can also be used with one processor.

Memory 506 can be non-transitory computer-readable media including a computer system memory or random access memory, such as DRAM, SRAM, EDO RAM, and the like. Memory 506 can include other types of memory as well, or combinations thereof.

A user can interact with the computing device 500 through a visual display device 518, such as a touch screen display or computer monitor, which can display one or more user interfaces 529 that can be provided in accordance with exemplary embodiments, for example, the exemplary interface illustrated in FIG. 3. The computing device 300 can include other I/O devices for receiving input from a user, for example, a keyboard or any suitable multi-point touch interface 508, a pointing device 510 (e.g., a pen, stylus, mouse, or trackpad). The keyboard 508 and the pointing device 510 can be coupled to the visual display device 518. The computing device 500 can include other suitable conventional I/O peripherals. In exemplary embodiments, the visual display device 518 can be an electronic-paper badge, E-ink device, LCD badge, or an Electronic Shelf Label (ESL)-type device.

The computing device 500 can also include one or more storage devices 524, such as a hard-drive, CD-ROM, or other non-transitory computer readable media, for storing data and computer-readable instructions and/or software, such as the impact parameter generator 531 and the performance ranking generator 533, which may generate user interface 529 that implements exemplary embodiments of the methods and systems as taught herein, or portions thereof. Exemplary storage device 524 can also store one or more databases 526 for storing any suitable information required to implement exemplary embodiments. The databases can be updated by a user or automatically at any suitable time to add, delete or update one or more items in the databases. Exemplary storage device 524 can store one or more databases 526 for storing product activity data, impact parameters, performance rankings, and any other data/information used to implement exemplary embodiments of the systems and methods described herein.

The computing device 500 can include a network interface 512 configured to interface via one or more network devices 522 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 512 can include a built-in network adapter, network interface card, PCMCIA network card, card bus network adapter, wireless network adapter, USB network adapter, modem or any other device suitable for interfacing the computing device 500 to any type of network capable of communication and performing the operations described herein. Moreover, the computing device 500 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 500 can be configured to run any operating system 516, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 516 can be run in native mode or emulated mode. In an exemplary embodiment, the operating system 516 can be run on one or more cloud machine instances

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A method for configuring a graphical user interface of an electronic display device, the method comprising:
receiving, in an electronic computer-readable format, activity data relating to one or more activities performed by an individual, wherein the activity data comprises an indication of a status of completion of the one or more activities;
computing an impact parameter associated with the individual, wherein the impact parameter is quantified using a metric based on predefined measures of the net value of the individual's performance with respect to the one or more activities;
computing a performance ranking associated with the individual, based on the one or more activities performed by the individual;
rendering a graphical user interface on an electronic display device, the graphical user interface comprising a graphical indication of the impact parameter, and a graphical indication of the performance ranking; and
updating the graphical user interface, in real-time, to indicate a modification of the graphical indication of the performance ranking and/or a modification of the graphical indication of the impact parameter, based on the activity data indicating completion of the one or more activities.

2. The method of claim 1, wherein the impact parameter includes a real money value reported as a result of the one or more activities performed by the individual.

3. The method of claim 1, wherein the impact parameter includes an increase in a customer satisfaction rating resulting from the one or more activities performed by the individual.

4. The method of claim 1, wherein the graphical user interface further comprises a graphical indication of the individual's progress in completing individual-specific goals relating to the individual's projected career path.

5. The method of claim 1, wherein performing a task at an improper time negatively effects the performance ranking or the impact parameter associated with the individual.

6. The method of claim 1, further comprising receiving, at a computing terminal, an audit request initiated by a second individual requesting an audit of the one or more activities performed by the individual.

7. The method of claim 1, wherein the activity data is input manually by the individual's manager or supervisor.

8. The method of claim 1, wherein the electronic display device is a mobile electronic device.

9. The method of claim 1, wherein the electronic display device is a wearable electronic-paper badge or a liquid crystal display (LCD) badge.

10. The method of claim 1, wherein the graphical user interface further comprises a graphical indication of an achievement earned by the individual in response to performing one or more specific tasks.

11. A system of configuring a graphical user interface of an electronic display device, the system comprising:
one or more servers programmed to:
receive, in an electronic computer-readable format, activity data relating to one or more activities performed by an individual, wherein the activity data comprises an indication of a status of completion of the one or more activities;
compute an impact parameter associated with the individual, wherein the impact parameter is quantified using a metric based on predefined measures of the net value of the individual's performance with respect to the one or more activities; and
compute a performance ranking associated with the individual, based on the one or more activities performed by the individual; and
an electronic display device programed to:
render a graphical user interface on an electronic display device, the graphical user interface comprising a graphical indication of the impact parameter, and a graphical indication of the performance ranking; and
update the graphical user interface, in real-time, to indicate a modification of the graphical indication of the performance ranking and/or a modification of the graphical indication of the impact parameter, based on the activity data indicating completion of the one or more activities.

12. The system of claim 11, wherein the impact parameter includes a real money value reported as a result of the one or more activities performed by the individual.

13. The system of claim 11, wherein the impact parameter includes an increase in a customer satisfaction rating resulting from the one or more activities performed by the individual.

14. The system of claim 11, wherein the graphical user interface further comprises a graphical indication of the individual's progress in completing individual-specific goals relating to the individual's projected career path.

15. The system of claim 11, wherein performing a task at an improper time negatively effects the performance ranking or the impact parameter associated with the individual.

16. The system of claim 11, further comprising a computing terminal programmed to receive an audit request initiated by a second individual requesting an audit of the one or more activities performed by the individual.

17. The system of claim 11, wherein the electronic display device is a mobile electronic device.

18. The system of claim 11, wherein the electronic display device is a wearable electronic-paper badge or a LCD badge.

19. The system of claim 11, wherein the graphical user interface further comprises a graphical indication of an achievement earned by the individual in response to performing one or more specific tasks.

20. A non-transitory computer readable medium storing instructions executable by a processing device, wherein execution of the instructions causes the processing device to implement a method of configuring a graphical user interface of an electronic display device, the method comprising:
receiving, in an electronic computer-readable format, activity data relating to one or more activities performed by an individual, wherein the activity data comprises an indication of a status of completion of the one or more activities;
computing an impact parameter associated with the individual, wherein the impact parameter is quantified using a metric based on predefined measures of the net value of the individual's performance with respect to the one or more activities;
computing a performance ranking associated with the individual, based on the one or more activities performed by the individual;
rendering a graphical user interface on an electronic display device, the graphical user interface comprising a graphical indication of the impact parameter, and a graphical indication of the performance ranking; and
updating the graphical user interface, in real-time, to indicate a modification of the graphical indication of the performance ranking and/or a modification of the graphical indication of the impact parameter, based on the activity data indicating completion of the one or more activities.
